(19) United States
(12) Patent Application Publication
(10) Pub. No.: US 2009/0232208 A1
(43) Pub. Date: Sep. 17, 2009

(54) METHOD AND APPARATUS FOR ENCODING AND DECODING IMAGE

(75) Inventors: Kyo-hyuk LEE, Yongin-si (KR); Woo-jin HAN, Suwon-si (KR); Sang-rae LEE, Suwon-si (KR); So-young KIM, Yongin-si (KR); Tammy Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/402,903

(22) Filed: Mar. 12, 2009

(30) Foreign Application Priority Data
Mar. 13, 2008 (KR) 10-2008-0023448

(51) Int. Cl. H04N 7/32

(52) U.S. Cl. 375/240.12; 375/E07.243

(57) ABSTRACT

Provided are a method and an apparatus for encoding and decoding an image to improve the efficiency for predicting an image by reducing discontinuity between prediction blocks by performing filtering on a prediction picture. The method of encoding an image includes generating filtered prediction pixel values by performing filtering in which a weighted sum of prediction pixels of a prediction picture with respect to peripheral prediction pixels is calculated, and encoding a difference value between the filtered prediction picture comprising the filtered prediction pixel values and a current picture.

### CROSS-REFERENCE TO RELATED PATENT APPLICATION

This application claims priority from Korean Patent Application No. 10-2008-0023448 filed on Mar. 13, 2008 in the Korean Intellectual Property Office, the disclosure of which is incorporated herein in its entirety by reference.

### BACKGROUND OF THE INVENTION

1. Field of the Invention

Methods and apparatuses consistent with the present invention relate to encoding and decoding an image, and more particularly, to encoding and decoding an image so as to improve the efficiency for predicting an image by reducing discontinuity between prediction blocks by performing filtering on a prediction picture.

2. Description of the Related Art

In image compression methods, such as Moving Pictures Experts Group-1 (MPEG-1), MPEG-2, MPEG-4, or H.264/MPEG-4 AVC (Advanced Video Coding), compression is performed by eliminating spatial redundancy and temporal redundancy in an image sequence. In order to eliminate spatial redundancy, a residual between a prediction image that is generated by using peripheral pixels adjacent to a current block of the prediction image and a previously-encoded portion of the prediction image is encoded. In order to eliminate temporal redundancy, a motion vector is generated by searching for a region that is similar to the current block to be encoded by using at least one reference picture that precedes or follows the current picture to be encoded. Based on the search, a differential value, which is a difference between a prediction block generated by motion compensation using the generated motion vector and the current block, is encoded.

FIG. 1 illustrates a related art method of generating a prediction picture of a current picture. Referring to FIG. 1, in order to generate a prediction block of the current picture, the current picture is divided into macro blocks having a predetermined size each Then, a region of a reference picture, which is similar to a region of a current macro block, is retrieved by using at least one reference picture restored after being encoded prior to the current picture, and a region of a reference picture, which is indicated by a motion vector, is obtained to generate the prediction picture of the current picture. As illustrated in FIG. 1, a prediction block of a first macro block MB1 is generated by using a region corresponding to a reference picture A and indicated by a motion vector MV1 that is generated as a result of motion prediction regarding the first macro block MB1 of the prediction picture. Similarly, a prediction block of a second macro block MB2 is generated by using a region corresponding to a reference picture B and indicated by a motion vector MV2 that is generated as a result of motion prediction regarding the second macro block MB2 of the prediction picture.

In the related art method of generating a prediction picture as shown in FIG. 1, e.g., intra prediction or inter prediction is performed in each macro block unit obtained by dividing the current picture, and thus, a boundary between macro blocks forming the prediction picture is subject to being discontinuous. Such discontinuity between prediction blocks is referred to as a prediction block artifact. In FIG. 1, a boundary between prediction blocks of each macro block is obtained by using data regarding different reference pictures. Thus, the characteristic of a pixel value is changed based on the boundary between prediction blocks, and discontinuity occurs. Such discontinuity between prediction blocks is a kind of edge component, which hinders an improvement in the efficiency for compressing an image. Further, the quality of the predicted image is deteriorated because of the block artifacts.

### SUMMARY OF THE INVENTION

The present invention provides a method and an apparatus for encoding and decoding an image to improve the efficiency for predicting an image by eliminating discontinuity that exists between prediction blocks in a prediction picture generated by performing prediction in units of blocks having a predetermined size each.

According to an aspect of the present invention, there is provided a method of encoding an image, the method including: dividing a current picture into blocks having a first size each and performing prediction in units of each block to generate a prediction picture of the current picture, the prediction picture comprising a plurality of prediction pixels; generating respective filtered pixel values of respective prediction pixels, among the plurality of the prediction pixels, by multiplying the prediction pixels located in a first region of the prediction picture with respective weights of a filter and summing the multiplied prediction pixels; and encoding a difference value between a filtered prediction picture comprising the generated filtered prediction pixel values and corresponding pixels of the current picture.

According to another aspect of the present invention, there is provided an apparatus for encoding an image, the apparatus including: a predicting unit which divides a current picture into blocks having a first size each and performing prediction in units of each block to generate a prediction picture of the current picture, the prediction picture comprising a plurality of prediction pixels; a filtering unit which generates respective filtered pixel values of respective prediction pixels, among the plurality of the prediction pixels, by multiplying the prediction pixels located in a first region of the prediction picture with respective weights of a filter and summing the multiplied prediction pixels; and an encoding unit which encodes a difference value between a filtered prediction picture comprising the generated filtered prediction pixel values and corresponding pixels of the current picture.

According to another aspect of the present invention, there is provided a method of decoding an image, the method including: extracting filtering information used to generate a filtered prediction picture of a current picture to be decoded, from an input bitstream; dividing the current picture into blocks having a first size each and performing prediction in units of each block to generate a prediction picture of the current picture, the prediction picture comprising a plurality of prediction pixels; generating respective filtered prediction pixel values of prediction pixels, among the plurality of the prediction pixels, by multiplying the prediction pixels located in a first region of the prediction picture with respective weights of a filter included in the extracted filtering information and summing the multiplied prediction pixels to generate the filtered prediction picture; and adding the filtered prediction picture comprising the filtered prediction pixel values and a residual of the current picture included in the input bitstream to restore the current picture.

According to another aspect of the present invention, there is provided an apparatus for decoding an image, the apparatus including: an entropy decoding unit which extracts filtering information used to generate a filtered prediction picture of a current picture to be decoded, from an input bitstream; a predicting unit which divides the current picture into blocks having a first size each and performing prediction in units of each block to generate a prediction picture of the current picture, the prediction picture comprising a plurality of prediction pixels; a filtering unit which generates respective filtered prediction pixel values of prediction pixels, among the plurality of the prediction pixels, by multiplying the prediction pixels located in a first region of the prediction picture with respective weights of a filter included in the extracted filtering information and summing the multiplied prediction pixels, and generates the filtered prediction picture based on the generated respective filtered prediction pixel values; and a restoring unit which adds the filtered prediction picture comprising the filtered prediction pixel values and a residual of the current picture included in the input bitstream to restore the current picture.

According to another aspect of the present invention, there is provided a computer readable recording medium storing computer readable code to be executed on a computer for implementing functions of encoding an image, said functions including: dividing a current picture into blocks having a first size each and performing prediction in units of each block to generate a prediction picture of the current picture, the prediction picture comprising a plurality of prediction pixels, generating respective filtered pixel values of respective prediction pixels, among the plurality of the prediction pixels, by multiplying the prediction pixels located in a first region of the prediction picture with respective weights of a filter and summing the multiplied prediction pixels, and encoding a difference value between a filtered prediction picture comprising the generated filtered prediction pixel values and corresponding pixels of the current picture.

According to another aspect of the present invention, there is provided a computer readable recording medium storing computer readable code to be executed on a computer for implementing functions of decoding an image, said functions including: extracting filtering information used to generate a filtered prediction picture of a current picture to be decoded, from an input bitstream, dividing the current picture into blocks having a first size each and performing prediction in units of each block to generate a prediction picture of the current picture, the prediction picture comprising a plurality of prediction pixels, generating respective filtered prediction pixel values of prediction pixels, among the plurality of the prediction pixels, by multiplying the prediction pixels located in a first region of the prediction picture with respective weights of a filter included in the extracted filtering information and summing the multiplied prediction pixels to generate the filtered prediction picture, and adding the filtered prediction picture comprising the filtered prediction pixel values and a residual of the current picture included in the input bitstream to restore the current picture.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a related art method of generating a prediction picture of a current picture;

FIG. 2 is a block diagram illustrating an apparatus for encoding an image, according to an exemplary embodiment of the present invention;

FIG. 3 illustrates a part of a prediction picture on which an operation of filtering is performed, according to an exemplary embodiment of the present invention;

FIG. 4 illustrates prediction pixels that exist in a filter of FIG. 3;

FIG. 5 illustrates a weight of the filter of FIG. 3;

FIG. 6 is a flowchart illustrating a method of encoding an image, according to an exemplary embodiment of the present invention;

FIG. 7 is a block diagram for illustrating an apparatus for decoding an image, according to an exemplary embodiment of the present invention; and

FIG. 8 is a flowchart illustrating a method of decoding an image, according to an exemplary embodiment of the present invention.

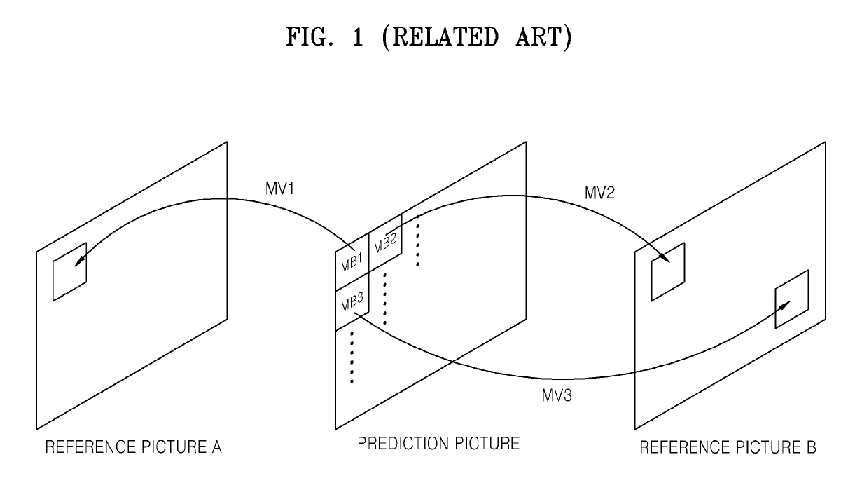

### DETAILED DESCRIPTION OF EXEMPLARY EMBODIMENTS OF THE INVENTION

The present invention will now be described more fully with reference to the accompanying drawings, in which exemplary embodiments of the invention are shown.

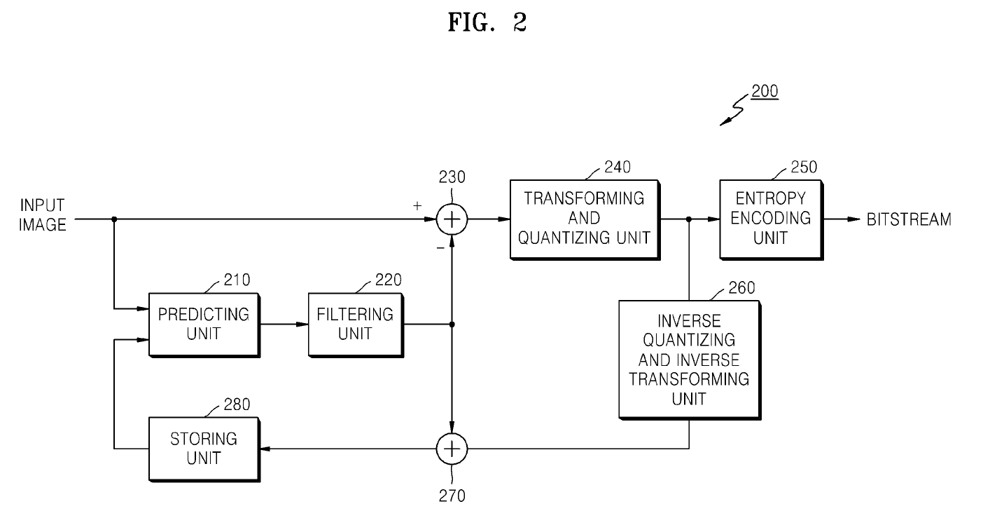

FIG. 2 is a block diagram illustrating an apparatus 200 for encoding an image, according to an exemplary embodiment of the present invention. Referring to FIG. 2, the apparatus 200 for encoding an image comprises a predicting unit 210, a filtering unit 220, a subtracting unit 230, a transforming and quantizing unit 240, an entropy encoding unit 250, an inverse quantizing and inverse transforming unit 260, an adding unit 270, and a storing unit 280.

The predicting unit 210 divides an input image into blocks having a predetermined size each, and generates a prediction block by performing inter prediction or intra prediction on each block. Specifically, the predicting unit 210 performs inter prediction by using motion prediction for generating a motion vector indicating a similar region to a current block within a predetermined search range of a reference picture and by using motion compensation for generating a prediction block of the current block by obtaining data regarding a region corresponding to the reference picture indicated by the generated motion vector. The reference picture is a picture that is restored after being previously encoded. In addition, the predicting unit 210 performs intra prediction for generating the prediction block by using data regarding a peripheral block adjacent to the current block. The related art method used in the image compression standard, such as H.264, or a variety of prediction methods different from the related art method may be used for the inter prediction and the intra prediction.

If the prediction with respect to all blocks in a current picture is completed and a prediction picture is generated, the filtering unit 220 generates a filtered value of pixels formed in the prediction picture (e.g., each pixel in the prediction picture or a portion of the pixels in the prediction picture) by performing a weighted sum operation (filtering) in which each of the pixels formed in a predetermined region of the prediction picture is multiplied by a predetermined weight and the multiplied pixels in the predetermined region are summed.

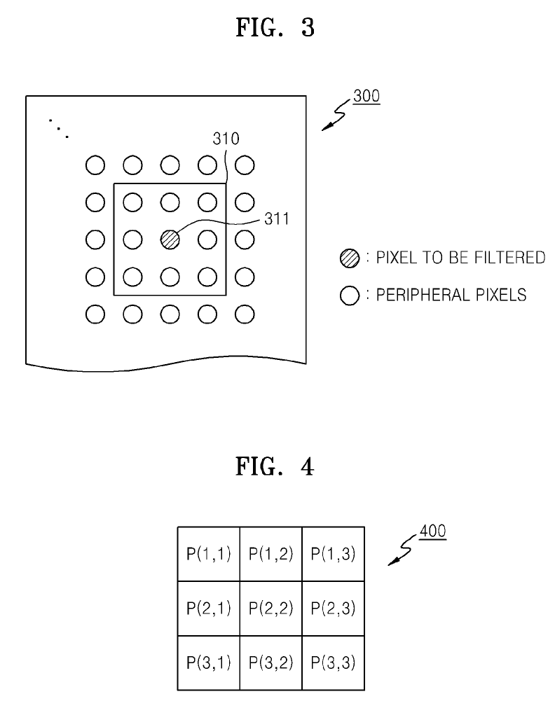

FIG. 3 illustrates a part 300 of a prediction picture on which an operation of filtering is performed and generated by the prediction unit 210, according to an exemplary embodiment of the present invention.

Referring to FIG. 3, the filtering unit 220 filters each prediction pixel in the prediction picture and generates a filtered prediction pixel value for each prediction pixel. Specifically, the center of a filter 310 having a size of N×M (N and M are positive odd numbers) is set based on a prediction pixel 311 to be currently filtered among the prediction pixels formed in the prediction picture. FIG. 3 illustrates the case where the filter 310 having a size of 3×3 is used in the filtering operation. The filtering unit 220 generates a filtered prediction pixel value of the pixel 311 to be currently filtered by calculating a weighted sum obtained by multiplying each of the prediction pixels disposed in the filter 310 by a predetermined weight and summing the multiplied pixels in the filter 310. For example, when a weight in an i-th (where i is an integer from 1 to N) row and a j-th (where j is an integer from 1 to M) column of a filter having a size of N×M is W(i, j), and when a prediction pixel that is located in a region of the filter having the size of N×M and corresponds to W(i, j) is P(i, j), and when the center of the filter having the size of N×M is set based on the prediction pixel to be filtered, a filtered pixel value P(i, j)′ of a prediction pixel to be filtered is generated by using Equation 1 shown below:

$${P ( i , j )}^{′} = {\sum }_{i = 1}^{N} {\sum }_{j = 1}^{M} ( W ( i , j ) \times P ( i , j ) ) \qquad ( 1 )$$

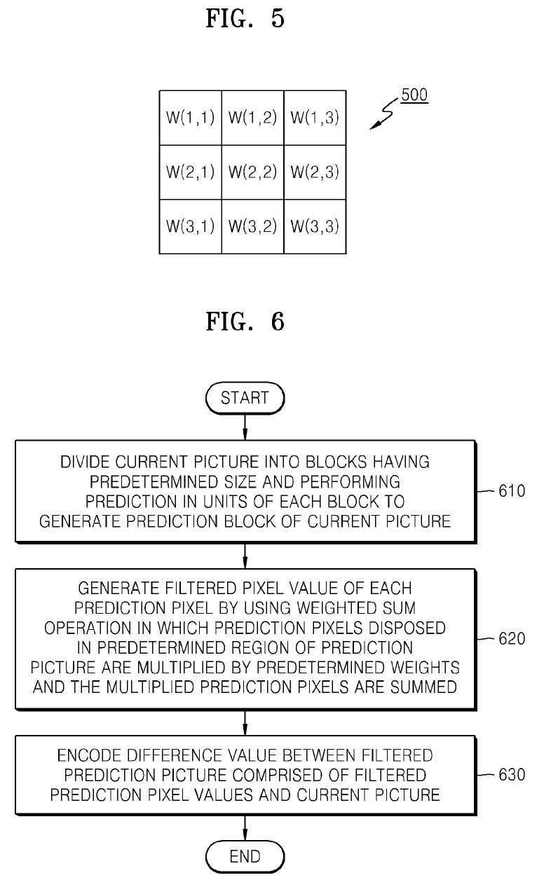

For example, referring to FIG. 4 which illustrates prediction pixels that exist in the filter 310 of FIG. 3 and FIG. 5 which illustrates a weight of the filter 310 of FIG. 3, a filtered pixel value P(2, 2) of the prediction pixel 311 to be currently filtered, of FIG. 3 is calculated by Equation 2 shown below:

$${P ( 2 , 2 )}^{′} = {\sum }_{i = 1}^{3} {\sum }_{j = 1}^{3} ( W ( i , j ) \times P ( i , j ) ) \qquad ( 2 )$$

A weight W(i, j) of a filter may be set in various ways. For example, a weight W(i, j) of a filter having a predetermined size N×M may be set to a weight having a maximum at the center position ((1+i)/2, (1+j)/2)) of the filter and is reduced as the weight W(i, j) is closer to a boundary between filters. When a weight of the filter is set in this manner, relatively more weight is applied to a prediction pixel to be currently filtered, and relatively less weight is applied to a peripheral prediction pixel so that the value of the peripheral prediction pixel can be reflected on the value of the prediction pixel to be currently filtered without changing the value of the prediction pixel to be currently filtered significantly. As a result, discontinuity that exists between prediction pixels can be reduced. In the above-mentioned example, the weight of a filter having a size of 3×3 may be a weight expressed as the following determinant:

$$( \begin{matrix}0 & 1 & 0 \\ 1 & 2 & 1 \\ 0 & 1 & 0\end{matrix} ) .$$

As described previously, the filtering unit 220 filters all pixels of a current prediction picture and the subtracting unit 230 generates a residual value which is a difference value between the current picture and the filtered prediction picture, if the filtered prediction picture is generated.

The transforming and quantizing unit 240 performs frequency transformation on the residual value and quantizes the transformed residual value. For instance, a discrete cosine transform (DCT) may be used to perform frequency transformation. The entropy encoding unit 250 performs variable length encoding on the quantized residual value to generate a bitstream. In this case, the entropy encoding unit 250 adds information regarding the weight used in filtering to the generated bitstream so that an apparatus for decoding an image can perform filtering on a prediction picture generated when prediction decoding is performed. If the apparatus for encoding an image and the apparatus for decoding an image previously set filter information, information regarding the weight used in filtering may not be separately transmitted.

The inverse quantizing and inverse transforming unit 260 performs inverse quantization and inverse transformation on the residual value to restore the residual value, and the adding unit 270 adds the restored residual value to the filtered prediction picture to restore the current picture. The restored current picture is stored by the storing unit 280 and is used in prediction encoding of a next picture.

Meanwhile, the operation of filtering the prediction picture according to an exemplary embodiment the present invention may be selectively performed. Specifically, filtering may be performed only on part of the blocks selected from the blocks disposed in the prediction picture. For example, filtering may be performed only on prediction blocks for which motion prediction and compensation is performed. Alternatively, a difference in averaged values between prediction blocks may be calculated and filtering may be performed only on prediction blocks having a difference in averaged values that are the same as or higher than a predetermined threshold value. In this case, predetermined binary information indicating whether filtering is to be performed may be added to a header of a bitstream in which each prediction block is encoded.

In addition, the entropy encoding unit 250 compares a cost of a first bitstream that is generated by encoding a difference value between a filtered prediction picture comprised of filtered pixel values and the current picture with a cost of a second bitstream that is generated by omitting filtering like in the related art and by encoding a difference value between the prediction picture and the current picture Based on the comparison, the entropy encoding unit 250 determines a bitstream having a smaller cost as a final bitstream, and adds predetermined binary information for identifying the determined bitstream to the final bitstream. For example, binary information ‘1’ is added to a header of a bitstream encoded by using the prediction picture on which filtering is performed according to an exemplary embodiment of the present invention, and binary information ‘0’ is added to a header of a bitstream encoded by using the prediction picture without an additional filtering operation so that the encoded bitstream can be identified by the apparatus for decoding an image.

FIG. 6 is a flowchart illustrating a method of encoding an image according to an exemplary embodiment of the present invention.

In operation 610, a current picture is divided into blocks having a predetermined size, and prediction is performed in units of each block, to generate a prediction picture of the current picture.

In operation 620, a filtered prediction pixel value of each prediction pixel is generated by using a weighted sum operation in which prediction pixels disposed or located in a predetermined region of the prediction picture are multiplied by predetermined weights and the multiplied prediction pixels in the predetermined region are summed, to generate a filtered prediction picture.

In operation 630, a difference value between the filtered prediction picture and the current picture is generated, the generated difference value is transformed, quantized, and entropy encoded to generate a bitstream. As described earlier, a cost of a first bitstream that is generated by encoding a difference value between the filtered prediction picture and the current picture may be compared with a cost of a second bitstream that is generated by omitting filtering and by encoding a difference value between the prediction picture and the current picture, and a bitstream having a smaller cost may be determined as a final bitstream. Predetermined binary information for identifying the determined bitstream may be added to the final bitstream.

In the method (shown in FIG. 6) and the apparatus 200 for encoding an image according to exemplary embodiments of the present invention, discontinuity that exists between prediction blocks is eliminated so that the efficiency for predicting an image is improved Thus, a peak signal to noise ratio (PSNR) of the image can be improved.

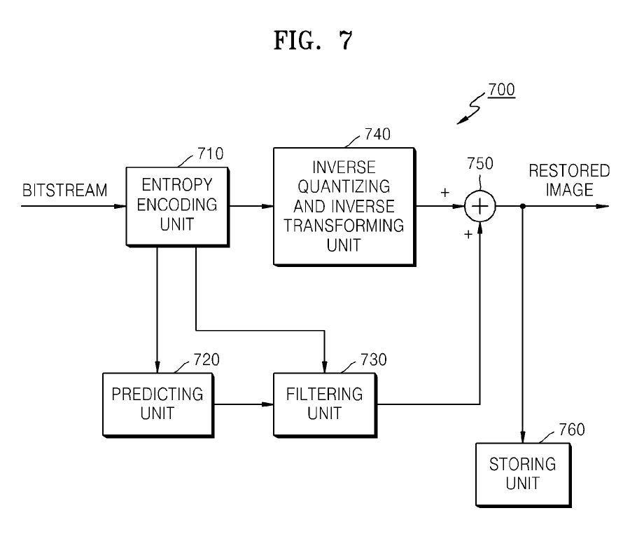

FIG. 7 is a block diagram illustrating an apparatus 700 for decoding an image, according to an exemplary embodiment of the present invention. Referring to FIG. 7, the apparatus 700 for decoding an image, according to the present exemplary embodiment comprises an entropy decoding unit 710, a predicting unit 720, a filtering unit 730, an inverse quantizing and inverse transforming unit 740, an adding unit 750, and a storing unit 760.

The entropy decoding unit 710 receives a compressed bitstream and performs entropy decoding to extract filtering information used in a prediction picture of a current picture disposed in the bitstream. In addition, the entropy decoding unit 710 extracts a prediction mode (e.g., block size) of blocks disposed in the current picture and residual information in which a difference value between the filtered prediction block and the input current block is transformed and quantized.

The inverse quantizing and inverse transforming unit 740 performs inverse quantization and inverse transformation on the residual values of blocks disposed in the current picture, to restore the residual values.

The predicting unit 720 generates a prediction block with respect to the blocks disposed in the current picture, according to the extracted prediction mode, to generate a prediction picture of the current picture. For example, a prediction block of an intra predicted block is generated by using peripheral data of the same frame previously-restored, and a prediction block of an inter predicted block is generated from data of a region in a reference picture by using a motion vector disposed in a bitstream and reference picture information included in the bitstream.

The filtering unit 730 generates a filtered pixel value of each prediction pixel included in the prediction picture by using a weighted sum operation in which prediction pixels located in a predetermined region of the prediction picture are multiplied by predetermined weights and the multiplied prediction pixels in the predetermined region are summed by using the extracted filtering information. Here, the filtering information may include information regarding a prediction block on which filtering is performed, among prediction blocks disposed in the current picture, and information regarding the weights of a filter used in filtering the prediction block. When an apparatus for encoding an image and an apparatus for decoding an image use a predetermined filter, information regarding the weights of an additional filter does not need to be included.

The adding unit 750 adds the filtered prediction picture and the respective restored residual value to restore the current picture. The restored current picture is stored by the storing unit 760 and is used in predicting a next picture.

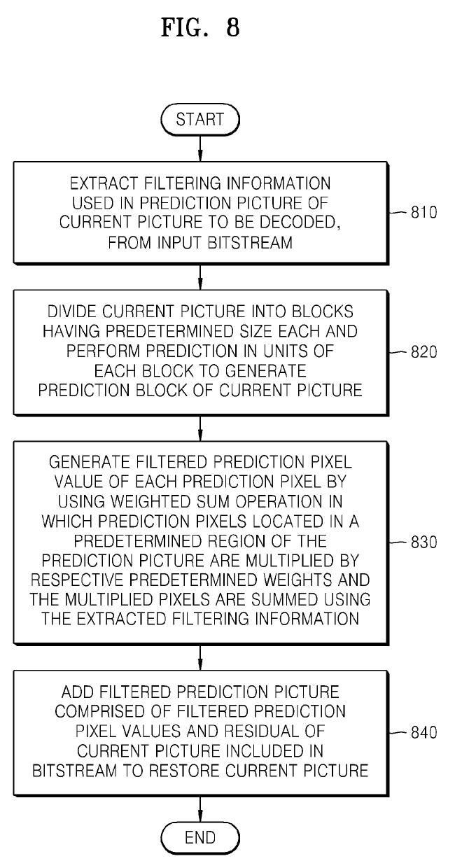

FIG. 8 is a flowchart illustrating a method of decoding an image, according to an exemplary embodiment of the present invention.

Referring to FIG. 8, in operation 810, filtering information used in a prediction picture of a current picture to be decoded is extracted from an input bitstream.

In operation 820, the current picture is divided into blocks having a predetermined size each, and prediction is performed in units of each block, to generate the prediction picture of the current picture. In this case, the prediction picture of the current picture to be decoded is generated by using information regarding a prediction mode included in the bitstream.

In operation 830, a filtered pixel value of each prediction pixel of the prediction picture is generated by using a weighted sum operation in which prediction pixels located in a predetermined region of the prediction picture are multiplied by predetermined weights and the multiplied prediction pixels in the predetermined region are summed using the filtering information extracted in operation 810. As described above, information regarding the weights of the filter included in the filtering information may be used as weights. When an apparatus for encoding an image and an apparatus for decoding an image use a predetermined filter, information regarding the weights of the filter does not need to be included. In this case, the prediction picture is filtered by using the weights of the predetermined filter.

In operation 840, the filtered prediction picture and the residual of the current picture that is extracted from the bitstream and restored are added to restore the current picture.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

The present invention can also be embodied as computer readable codes on a transmittable recording medium. The transmittable recording medium is any medium that can be transmitted via the air by means of transmitting and receiving antennae or via a transmission line. For example, the transmittable recording medium could be carrier waves (such as data transmission through the Internet). The transmittable recording medium can also be distributed over network coupled computer systems so that the computer readable code is stored and executed in a distributed fashion.

According to exemplary embodiments of the present invention, discontinuity between prediction blocks is eliminated such that the efficiency for predicting an image and a peak signal to noise ratio (PSNR) are improved.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of encoding an image, the method comprising:
dividing a current picture into blocks having a first size each and performing prediction in units of each block to generate a prediction picture of the current picture, the prediction picture comprising a plurality of prediction pixels;
generating respective filtered pixel values of respective prediction pixels, among the plurality of the prediction pixels, by multiplying the prediction pixels located in a first region of the prediction picture with respective weights of a filter and summing the multiplied prediction pixels; and
encoding a difference value between a filtered prediction picture comprising the generated filtered prediction pixel values and corresponding pixels of the current picture.

2. The method of claim 1, wherein the generating of the filtered prediction pixel value of each prediction pixel comprises, when a weight in an i-th (where i is an integer from 1 to N) row and a j-th (where j is an integer from 1 to M) column of the filter having a size of N×M is W(i, j), and when a prediction pixel P(i, j) to be filtered, among the prediction pixels, is located in a region of the filter corresponding to W(i, j), and when a center of the filter is set based on the prediction pixel to be filtered, generating a filtered pixel value P(i, j)′ of the prediction pixel P(i,j) by using the equation
$${P ( i , j )}^{′} = {\sum }_{i = 1}^{N} {\sum }_{j = 1}^{M} ( W ( i , j ) \times P ( i , j ) ) .$$

3. The method of claim 2, wherein the weight W(i, j) of the filter having the size of N×M has a maximum at the center ((1+i)/2, (1+j)/2)) of the filter and is reduced as the weight W(i, j) is closer to a boundary between filters.

4. The method of claim 2, wherein the size of the filter is 3×3, and the filter has a weight expressed as the following determinant:
$$( \begin{matrix}0 & 1 & 0 \\ 1 & 2 & 1 \\ 0 & 1 & 0\end{matrix} ) .$$

5. The method of claim 1, further comprising:
comparing a first cost of a first bitstream, which is generated by encoding the difference value with a second cost of a second bitstream, which is generated by encoding a second difference value between the prediction picture that is not filtered and the corresponding pixels of the current picture; and
determining, between the first bitstream and the second bitstream, a bitstream having a smaller cost among the first cost and the second cost, as a final bitstream; and
adding predetermined binary information to the final bitstream for identifying the determined bitstream.

6. The method of claim 1, further comprising adding weight information including the weights of the filter used in generating the respective filtered pixel values to a header of a bitstream generated as a result of the encoding.

7. The method of claim 1, wherein the generating the respective filtered prediction pixel values is performed only on part of the blocks selected from the blocks included in the prediction picture.

8. An apparatus for encoding an image, the apparatus comprising:
a predicting unit which divides a current picture into blocks having a first size each and performing prediction in units of each block to generate a prediction picture of the current picture, the prediction picture comprising a plurality of prediction pixels;
a filtering unit which generates respective filtered pixel values of respective prediction pixels, among the plurality of the prediction pixels, by multiplying the prediction pixels located in a first region of the prediction picture with respective weights of a filter and summing the multiplied prediction pixels; and
an encoding unit which encodes a difference value between a filtered prediction picture comprising the generated filtered prediction pixel values and corresponding pixels of the current picture.

9. The apparatus of claim 8, wherein when a weight in an i-th (where i is an integer from 1 to N) row and a j-th (where j is an integer from 1 to M) column of the filter having a size of N×M is W(i, j), and when a prediction pixel P(i, j) to be filtered, among the prediction pixels, is located in a region of the filter corresponding to W(i, j), and when a center of the filter is set based on the prediction pixel to be filtered, the filtering unit generates a filtered pixel value P(i, j)′ of the prediction pixel P(i,j) by using the equation
$${P ( i , j )}^{′} = {\sum }_{i = 1}^{N} {\sum }_{j = 1}^{M} ( W ( i , j ) \times P ( i , j ) ) .$$

10. The apparatus of claim 9, wherein the weight W(i, j) of the filter having the size of N×M has a maximum at the center ((1+i)/2, (1+j)/2)) of the filter and is reduced as the weight W(i, j) is closer to a boundary between filters.

11. The apparatus of claim 9, wherein the size of the filter is 3×3, and the filter has a weight expressed as the following determinant:
$$( \begin{matrix}0 & 1 & 0 \\ 1 & 2 & 1 \\ 0 & 1 & 0\end{matrix} ) .$$

12. The apparatus of claim 8, wherein the encoding unit compares a first cost of a first bitstream, which is generated by encoding the difference value with a second cost of a second bitstream, which is generated by encoding a second difference value between the prediction picture that is not filtered and the corresponding pixels of the current picture, determines, between the first bitstream and the second bitstream, a bitstream having a smaller cost among the first cost and the second cost as a final bitstream, and adds predetermined binary information to the final bitstream for identifying the determined bitstream.

13. The apparatus of claim 8, wherein the encoding unit adds weight information used in filtering the prediction picture to a header of the bitstream generated as a result of the encoding.

14. A method of decoding an image, the method comprising:
extracting filtering information used to generate a filtered prediction picture of a current picture to be decoded, from an input bitstream;
dividing the current picture into blocks having a first size each and performing prediction in units of each block to generate a prediction picture of the current picture, the prediction picture comprising a plurality of prediction pixels;
generating respective filtered prediction pixel values of prediction pixels, among the plurality of the prediction pixels, by multiplying the prediction pixels located in a first region of the prediction picture with respective weights of a filter included in the extracted filtering information and summing the multiplied prediction pixels to generate the filtered prediction picture; and
adding the filtered prediction picture comprising the filtered prediction pixel values and a residual of the current picture included in the input bitstream to restore the current picture.

15. The method of claim 14, wherein the weights include information regarding a weight W(i, j) in an i-th (where i is an integer from 1 to N) row and a j-th (where j is an integer from 1 to M) column of the filter having a size of N×M, and
when a prediction pixel P(i,j) to be filtered, among the prediction pixels, is located in a region of the filter corresponding to W(i, j), and when a center of the filter is set based on the prediction pixel to be filtered, the generating the respective filtered prediction pixel values comprises generating a filtered pixel value P(i, j)′ of the prediction pixel P(i,j) by using the equation
$${P ( i , j )}^{′} = {\sum }_{i = 1}^{N} {\sum }_{j = 1}^{M} ( W ( i , j ) \times P ( i , j ) ) .$$

16. The method of claim 15, wherein the weight W(i, j) of the filter having the size of N×M has a maximum at the center ((1+i)/2, (1+j)/2)) of the filter and is reduced as the weight W(i, j) is closer to a boundary between filters.

17. The method of claim 15, wherein the size of the filter is 3×3, and the filter has a weight expressed as the following determinant:
$$( \begin{matrix}0 & 1 & 0 \\ 1 & 2 & 1 \\ 0 & 1 & 0\end{matrix} ) .$$

18. An apparatus for decoding an image, the apparatus comprising:
an entropy decoding unit which extracts filtering information used to generate a filtered prediction picture of a current picture to be decoded, from an input bitstream;
a predicting unit which divides the current picture into blocks having a first size each and performing prediction in units of each block to generate a prediction picture of the current picture, the prediction picture comprising a plurality of prediction pixels;
a filtering unit which generates respective filtered prediction pixel values of prediction pixels, among the plurality of the prediction pixels, by multiplying the prediction pixels located in a first region of the prediction picture with respective weights of a filter included in the extracted filtering information and summing the multiplied prediction pixels, and generates the filtered prediction picture based on the generated respective filtered prediction pixel values; and
a restoring unit which adds the filtered prediction picture comprising the filtered prediction pixel values and a residual of the current picture included in the input bitstream to restore the current picture.

19. The apparatus of claim 18, wherein the weights include information regarding a weight W(i, j) in an i-th (where i is an integer from 1 to N) row and a j-th (where j is an integer from 1 to M) column of the filter having a size of N×M, and
when a prediction pixel P(i,j) to be filtered, among the prediction pixels, is located in a region of the filter corresponding to W(i, j), and when a center of the filter is set based on the prediction pixel to be filtered, the filtering unit generates the respective filtered prediction pixel values comprises generating a filtered pixel value P(i, j)′ of the prediction pixel P(i,j) by using the equation
$${P ( i , j )}^{′} = {\sum }_{i = 1}^{N} {\sum }_{j = 1}^{M} ( W ( i , j ) \times P ( i , j ) ) .$$

20. The apparatus of claim 19, wherein the weight W(i, j) of the filter having the size of N×M has a maximum at the center ((1+i)/2, (1+j)/2)) of the filter and is reduced as the weight W(i, j) is closer to a boundary between filters.

21. The apparatus of claim 19, wherein the size of the filter is 3×3, and the filter has a weight expressed as the following determinant:
$$( \begin{matrix}0 & 1 & 0 \\ 1 & 2 & 1 \\ 0 & 1 & 0\end{matrix} ) .$$

22. A computer readable recording medium storing computer readable code to be executed on a computer for implementing functions of encoding an image, said functions comprising:
dividing a current picture into blocks having a first size each and performing prediction in units of each block to generate a prediction picture of the current picture, the prediction picture comprising a plurality of prediction pixels;
generating respective filtered pixel values of respective prediction pixels, among the plurality of the prediction pixels, by multiplying the prediction pixels located in a first region of the prediction picture with respective weights of a filter and summing the multiplied prediction pixels; and
encoding a difference value between a filtered prediction picture comprising the generated filtered prediction pixel values and corresponding pixels of the current picture.

23. A computer readable recording medium storing computer readable code to be executed on a computer for implementing functions of decoding an image, said functions comprising:
extracting filtering information used to generate a filtered prediction picture of a current picture to be decoded, from an input bitstream;
dividing the current picture into blocks having a first size each and performing prediction in units of each block to generate a prediction picture of the current picture, the prediction picture comprising a plurality of prediction pixels;
generating respective filtered prediction pixel values of prediction pixels, among the plurality of the prediction pixels, by multiplying the prediction pixels located in a first region of the prediction picture with respective weights of a filter included in the extracted filtering information and summing the multiplied prediction pixels to generate the filtered prediction picture; and
adding the filtered prediction picture comprising the filtered prediction pixel values and a residual of the current picture included in the input bitstream to restore the current picture.
